(19) United States
(12) Patent Application Publication
(10) Pub. No.: US 2025/0208571 A1
(43) Pub. Date: Jun. 26, 2025

(54) ONE-PIECE, DOUBLE-TOOTHING WHEEL SET FOR A HOROLOGICAL MOVEMENT

(71) Applicant: Montres Breguet S.A., L'Abbaye (CH)

(72) Inventors: Jérôme Mace, Le Pont (CH); Gregory Gauthier, Saint-Cergue (CH)

(73) Assignee: Montres Breguet S.A., L'Abbaye (CH)

(21) Appl. No.: 18/966,725

(22) Filed: Dec. 3, 2024

(30) Foreign Application Priority Data
Dec. 21, 2023 (EP) 23219309.4

(51) Int. Cl. G04B 13/02

(52) U.S. Cl. CPC G04B 13/027

(57) ABSTRACT

A one-piece wheel set (20) including a first toothing (203) formed on the periphery of a first platform (201), and a second toothing (204) formed on the periphery of a second platform (202) integral with the first platform (201), the first toothing (203) includes a number of teeth which is an integer multiple of the number of teeth in the second toothing (204).

### CROSS REFERENCE TO RELATED APPLICATIONS

This application claims priority to European Patent Application No. 23219309.4 filed Dec. 21, 2023, the entire contents of which are incorporated herein by reference.

### TECHNICAL FIELD OF THE INVENTION

The invention relates to horological movements, and more particularly to the gear trains of horological movements, for example the gear trains of horological complications allowing additional information to be displayed on the basis of a going train.

The invention relates more particularly to a one-piece, double-toothing wheel set which provides a dual function for a horological movement.

The invention further relates to a horological movement comprising such a one-piece double-toothing wheel set.

The invention further relates to a timepiece, for example a wristwatch, comprising a horological movement including such a one-piece double-toothing wheel set.

### TECHNOLOGICAL BACKGROUND

In watchmaking, it is not uncommon to propose horological movements with complications, such as calendar mechanisms or moon-phase mechanisms comprising driving trains associated with these complications and which are kinematically driven by the going train of the horological movement.

Such driving trains include multiple wheel sets that provide the necessary gear reductions from the going train. Some complications also require the use of indexing jumpers which are associated with specific wheels in the driving train to ensure that the displays are held in a stable position and, if necessary, to compensate for play between the gears.

Increasing the number of wheel sets in the horological movement increases the size of the horological movement, which is always problematic because a horological movement should ideally take up as little space as possible.

Moreover, increasing the number of wheel sets in a driving train means increasing the number of gears and thus play between the gears due to the increase in the chain of tolerances between the going train and the display of the complication, which can lead to jitter or an uncertain display.

Finally, increasing the number of wheels in a gear train also increases the energy consumption of the horological movement.

To avoid this unwanted play, wheel sets with a so-called flexible toothing are used, in order to compensate for certain amounts of play in the driving train. However, these solutions are complicated to manufacture and implement. Moreover, they do not allow the size of the horological movement to be reduced.

As a result, there is a need to improve horological movements that comprise complications.

### SUMMARY OF THE INVENTION

In this context, the invention relates to a one-piece wheel set comprising a first toothing formed on the periphery of a first platform, and a second toothing formed on the periphery of a second platform integral with the first platform, characterised in that the first toothing comprises a number of teeth which is an integer multiple of the number of teeth in the second toothing.

A one-piece wheel set of this type can thus perform a dual function by providing a toothing over a plurality of levels.

A one-piece wheel set of this type guarantees perfect alignment between the two toothing levels, eliminating alignment problems when mounting a plurality of wheels on the same wheel set arbor.

Preferably, a first level of the one-piece wheel set is configured to cooperate with a jumper and a second level of the one-piece wheel set is configured to be kinematically linked to a drive wheel, for example to a wheel kinematically linked to the going train. Thus, such a one-piece wheel set makes it possible to reduce the number of wheel sets in a gear train by combining multiple functions with a single one-piece wheel set.

In addition to the features mentioned in the preceding paragraph, the one-piece wheel set according to the invention can have one or more complementary features from among the following, considered either on an individual basis or according to any combination technically possible:
the first toothing is configured to mesh with a toothed drive wheel;
the second toothing is configured to cooperate with a jumper to index the position of said one-piece wheel set, in steps;
the number of teeth in the second toothing corresponds to the number of steps through which said one-piece wheel set is driven in order for it to make one complete revolution;
the teeth in the second toothing are aligned with the teeth in the first toothing;
the teeth in the second toothing are continuous with certain teeth in the first toothing with an alternation corresponding to the ratio between the number of teeth in the first toothing and the number of teeth in the second toothing;
the one-piece wheel set is made of a metal, a metal alloy or a ceramic material;
the one-piece wheel set is obtained by milling.

Another aspect of the invention relates to a horological movement comprising a one-piece wheel set according to the invention. Such a one-piece wheel set can, for example, be part of a gear train driving a complication display.

Preferably, the horological movement comprises a going train for displaying time information and a secondary driving train for displaying additional information, said secondary driving train being meshed with the going train, the one-piece wheel set belonging to the secondary driving train.

Preferably, the secondary driving train comprises a jumper cooperating with the second toothing of the one-piece wheel set, the first toothing of the one-piece wheel set cooperating with a toothed drive wheel belonging to the going train or to the secondary driving train.

The invention further relates to a timepiece comprising a horological movement according to the invention.

The timepiece is, for example, a wristwatch including a watch case configured to receive and house the horological movement according to the invention.

### BRIEF DESCRIPTION OF THE FIGURES

The purposes, advantages and features of the present invention will be better understood upon reading the detailed description given below with reference to the following figures:

FIG. 1 is a top view diagrammatically illustrating a one-piece double-toothing wheel set according to the invention in a driving train of a horological movement;

FIG. 2 is a perspective view of the one-piece double-toothing wheel set illustrated in FIG. 1 in a driving train of a horological movement;

FIG. 3 is a diagrammatic view of a timepiece incorporating a horological movement according to the invention;

FIG. 4 is a block diagram of the timepiece comprising a horological movement according to the invention.

In all the figures, common elements bear the same reference numerals unless specified to the contrary.

### DETAILED DESCRIPTION OF THE INVENTION

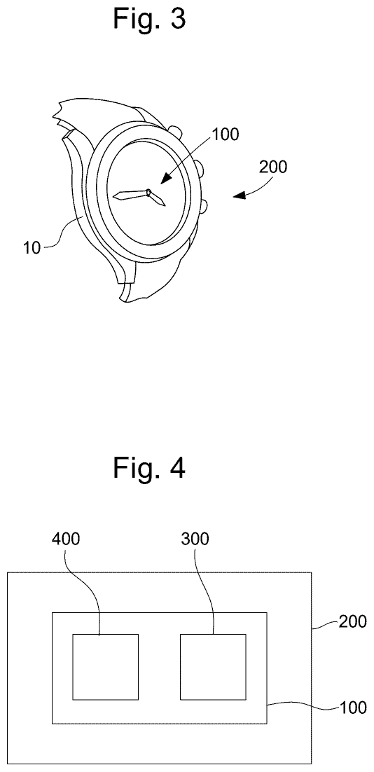

With reference to FIGS. 3 and 4, the present invention proposes a timepiece 200, such as a wristwatch, comprising a horological movement 100 according to the invention.

The horological movement 100 is mounted in a case 10 of the timepiece 200.

With reference to FIG. 4, the horological movement 100 comprises a going train 400 for displaying time information.

The horological movement 100 further includes a secondary driving train 300 configured to allow additional information to be displayed, for example a date, calendar-related information or, more broadly, information related to the solar cycle or to the lunar cycle.

The secondary driving train 300 is kinematically linked to the going train 400. More particularly, the secondary driving train 300 is kinematically linked to a wheel set of the going train 400. By way of example, the secondary driving train 300 can be kinematically linked and meshed with a wheel making one revolution every 12 hours or with a wheel making one revolution every 24 hours.

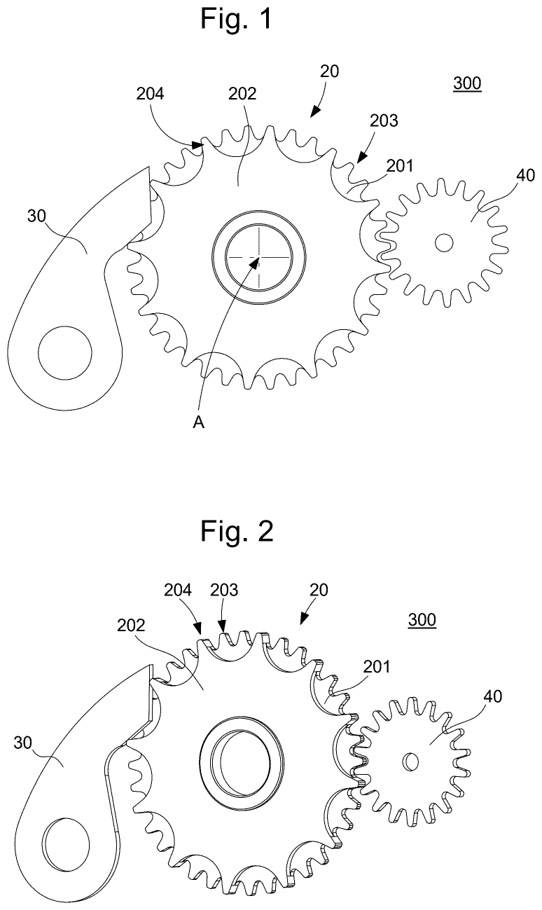

With reference to FIGS. 1 and 2, the secondary driving train 300 comprises a one-piece double-toothing wheel set 20, allowing a dual function to be carried out while offering a compact solution.

The one-piece wheel set 20 comprises a first toothing 203 formed on the periphery of a first platform 201 and a second toothing 204 formed on the periphery of a second platform 202 integral with the first platform 201.

The one-piece wheel set 20 is rigidly connected to an arbor or axle so that it can pivot about the axis of rotation A.

The first toothing 203 of the one-piece wheel set 20 has a number of teeth that is an integer multiple of the number of teeth in the second toothing 204.

In the example embodiment shown, the first toothing 203 has 36 teeth and the second toothing 204 has 12 teeth. In this example, there is a ratio of 3 between the two toothings 203, 204 of the one-piece wheel set 20.

The ratio between the two toothings can be adapted according to requirements and the number of steps needed to make a complete revolution.

The number of teeth in the second toothing 204 corresponds to the number of steps through which said one-piece wheel set 20 is driven in order for it to make one complete revolution.

The one-piece wheel set 20 is rotated by a toothed drive wheel 40 configured to cooperate with the first toothing 203.

The toothed drive wheel 40 can belong to the secondary driving train or to the going train 400.

Preferably, the toothed drive wheel 40 is meshed with the first toothing 203 of the one-piece wheel set 20.

The second toothing 204 is configured to cooperate with a jumper 30 included in the secondary driving train 300. The jumper 30 is used to index the position of the one-piece wheel set 20 in successive steps.

Typically, the jumper 30 cooperates with a spring (not shown) configured to bring the end of jumper 30 into contact with two consecutive teeth in the second toothing 204.

The end of the jumper 30 has two inclined planes which bear between the two consecutive tooth tips of the second toothing 204 of the one-piece wheel set 20.

The teeth in the second toothing 204 are aligned with the teeth in the first toothing 203.

The teeth in the second toothing 204 are axially continuous with certain teeth in the first toothing 203 with an alternation corresponding to the ratio between the number of teeth in the first toothing 203 and the number of teeth in the second toothing 203.

Thus, the teeth in the second toothing 204 coincide with certain teeth in the first toothing 203 to form teeth extending over both levels of the platforms 201, 202.

Thus, the teeth in the second toothing 204 have a tip that is coincident with the tip of the teeth in the first toothing 203 to form a common tooth over both levels of the platforms 201, 202.

The one-piece wheel set 20 can be made of a metal, a metal alloy or a ceramic material.

The one-piece wheel set 20 is produced by milling. Preferably, the second toothing 204 forming the second level of the one-piece wheel set 20 is produced, by milling, from the first toothing 203, which has already been milled. This ensures perfect alignment between the two toothings 203, 204 of the one-piece wheel set 20.

1. A one-piece wheel set comprising a first toothing formed on the periphery of a first platform, and a second toothing formed on the periphery of a second platform integral with the first platform, wherein the first toothing comprises a number of teeth which is an integer multiple of the number of teeth in the second toothing.

2. The one-piece wheel set according to claim 1, wherein the first toothing is configured to mesh with a toothed drive wheel.

3. The one-piece wheel set according to claim 1, wherein the second toothing is configured to cooperate with a jumper to index the position of said one-piece wheel set, in steps.

4. The one-piece wheel set according to claim 1, wherein the number of teeth in the second toothing corresponds to the number of steps through which said one-piece wheel set is driven in order for it to make one complete revolution.

5. The one-piece wheel set according to claim 1, wherein the teeth in the second toothing are aligned with the teeth in the first toothing.

6. The one-piece wheel set according to claim 1, wherein the teeth in the second toothing are continuous with certain teeth in the first toothing with an alternation corresponding to the ratio between the number of teeth in the first toothing and the number of teeth in the second toothing.

7. The one-piece wheel set according to claim 1, wherein the one-piece wheel set is made of a metal, a metal alloy or a ceramic material.

8. The one-piece wheel set according to claim 1, wherein the one-piece wheel set is obtained by milling.

9. A horological movement comprising the one-piece wheel set according to claim 1.

10. The horological movement according to claim 9, wherein the horological movement comprises a going train for displaying time information and a secondary driving train for displaying additional information, said secondary driving train being meshed with the going train, the one-piece wheel set belonging to the secondary driving train.

11. The horological movement according to claim 9, wherein the secondary driving train comprises a jumper cooperating with the second toothing of the one-piece wheel set, the first toothing of the one-piece wheel set cooperating with a toothed drive wheel belonging to the going train or to the secondary driving train.

12. A timepiece comprising the horological movement according to claim 9.

13. The timepiece according to claim 12, wherein said timepiece is a wristwatch including a watch case configured to receive and house the horological movement.
